(19) United States
(12) Patent Application Publication
(10) Pub. No.: US 2015/0344669 A1
(43) Pub. Date: Dec. 3, 2015

(54) TRANSPARENT POLYESTER ARTICLES

(71) Applicant: DSM IP ASSETS B.V., Heerlen (NL)

(72) Inventors: Ronald MichaëL Alexander Maria SCHELLEKENS, Echt (NL); Luc Elza Florent LEEMANS, Echt (NL)

(21) Appl. No.: 14/652,564

(22) PCT Filed: Dec. 13, 2013
(86) PCT No.: PCT/EP2013/076488

§ 371 Date: Jun. 16, 2015

(30) Foreign Application Priority Data
Dec. 18, 2012 (EP) 12197837.3

(51) Int. Cl. C08K 5/22; C08K 5/11; C08K 5/101

(52) U.S. Cl. CPC C08K 5/22; C08K 5/101; C08K 5/11

(57) ABSTRACT

The invention relates to a method for injection moulding an article having a thickness of between 1 to 3 mm and having a b value in the CIE colour system of between −1 and +0.1 and a haze value of less than 2%, as measured at 2 mm thickness, comprising the following steps: a) Providing a composition comprising: i) a polyester produced by copolymerizing, in the presence of an aluminum or germanium compound, at least three monomers chosen from at least one alkylenediol and at least one dicarboxylic acid component, ii) from 1 to 5 ppm of at least one dye and iii) from 0.1 to 0.5 m % of a fatty acid ester mould release agent, b) Injecting the composition in a mould at a temperature of below 60° C. until the mould is filled; c) Ejecting the article. The invention further relates to a composition comprising, A) a polyester produced by copolymerizing 1,2-ethanediol and two dicarboxylic acid components in the presence of a germanium compound, the dicarboxylic acid components comprising a terephthalic acid component and 4-20 mol % of an isophthalic acid component, the mol % being relative to the total amount of the dicarboxylic acid component, characterised that the composition further comprises, B) from 0.2 to 1.5 ppm of at least one dye, C) from 0.1 to 0.5 m % of stearylstearateor glyceroltristearate and to an article having a wall thickness of between 1 and 3 mm comprising this composition.

The invention relates to a method for producing a transparent polyester article consumer packaging. The invention further relates to a moulding composition suitable to obtain said transparent polyester article.

A process for the production of transparent polyester is known from U.S. Pat. No. 3,822,332. U.S. Pat. No. 3,822,332 relates to a process for the production of transparent articles with polyester moulding materials. Especially suitable are copolyesters produced from terephthalic acid, 2-20 mol % isophthalic acid and ethylene glycol, or from terephthalic acid, ethylene glycol and 20 mol % of a second diol. Copolyesters for use in the process of U.S. Pat. No. 3,822,332 are produced in a known manner by esterification or transesterification followed by melt condensation polymerisation. For the polymerisation step a germanium catalyst can be employed. Mould temperatures for the production of articles are typically between 70 and 80° C.

A disadvantage of the method described in U.S. Pat. No. 3,822,332 is that a transparent article made accordingly is still slightly yellow and hazy seen in a direction parallel to a surface of the article. Yellowness, which may be measured as b values in the CIE colour system, is a particularly undesirable colour in consumer packaging. Although it is known in the art to shift the b value from yellow to blue by adding colourants, these generally increase the haziness.

Another disadvantage of the composition described in U.S. Pat. No. 3,822,332 is that forces to release the article from a mould are relatively high, which may result in surface defects. Mould release agents can decrease release forces. However mould release agents also may decrease the transparency.

It has surprisingly been found, that the method according to claim 1 reveals colourless and highly transparent articles with low release forces after injection moulding.

The process of the present invention is limited to articles of between 1 and 3 mm wall thickness. At a wall thickness of less than 1 mm or more than 3 mm, an increase of haziness is observed under the conditions of the present process.

The process of the present invention comprises three steps.

In a first step a composition, comprising three components is provided. The first component is a polyester produced by copolymerising in the presence of an aluminium or germanium compound at least three monomers chosen from at least one alkylenediol and at least one dicarboxylic acid moiety, the third monomer being a alkylenediol or a dicarboxylic acid moiety.

The at least one alkylenediol is generally ethylene glycol.

The at least one dicarboxylic acid moiety is e.g terephthalic acid or an ester thereof. If the third component is a second alkylenediol this second diol is generally present in a molar ratio with respect to the first diol of between 2 and 20 mol %. The second diol can be chosen e.g. from diethylene glycol, cyclohexane dimethanol, 1,3-propanediol, 1,2-propanediol, 1,4-butanediol, 1,6-hexanediol, 1,6-trimethylhexanediol, and 2,2,4,4-tetramethyl-1,3-cyclobutanediol. If the third component is a second dicarboxylic acid moiety, the second dicarboxylic acid moiety is generally present in a molar ratio with respect to the first dicarboxylic acid moiety of between 4 and 15 mol %. If e.g. the first dicarboxylic acid moiety is a terephthalic moiety, the second dicarboxylic acid moiety typically is an isophthalic moiety.

The second component of the composition suitable for the process of the invention is at least one dye present in an amount of between 0.2 and 1.5 ppm related to the polyester component. The advantage of a dye in the process of the invention to shift the b value, is that a dye has hardly any, or no negative effect on haze and transparency.

The third component of the composition for the process of the invention is a fatty acid ester mould release agent in an amount from 0.1 to 0.5 m % based on the weight of the polyester. Surprisingly we found that the type of fatty acid ester mould release should be chosen in function of the composition of the copolyester. With this knowledge, a person skilled in the art can easily, without undue experimentation or burden determine a combination of copolyester and fatty acid ester that results in a low haze value.

The at least one dye and mould release agent can be mixed with the copolymerised polyester component by a melt dusting or compounding process. The polyester compound is preferably mixed with from 0.2 to 1.5 ppm of at least one dye and from 0.1 to 0.5 m % of a fatty acid ester mould release agent by a melt dusting process, as this results, after injection moulding of the composition in a b value closer to zero.

In a second step of the process of the invention the composition is injected in a mould until the mould is filled at a mould temperature of below 60° C., preferably below 55° C., and more preferably below 50° C. The mould will generally have a temp above 10° C., or above 20° C. The lower limit is chosen in function of the relative humidity in a space around the mould, to avoid condensation on the article. Cylinder temperatures in the process of the invention are preferably between 260 and 290° C.

In a third step of the process of the invention, the article is ejected from the mould.

A further object of the present invention is to provide a moulding composition that requires relatively low release forces to release an article made from that moulding composition from a mould and which the article has a reduced or no yellowness, seen in a direction parallel to a surface of the moulding.

According to the invention this object is obtained by the features of claim 3.

The composition comprises three components. A copolymerised polyester as the main component of the composition of the present invention can be produced by any polymerisation method, which is conventionally known as melt polycondensation. For example, a polycondensation method may be adopted, which method comprises the steps of directly esterifying ethylene glycol and at least two dicarboxylic acid moieties, optionally under pressure and thereafter gradually reducing the pressure while raising the temperature to effect polycondensation of the reaction product.

It is also possible to produce a copolymerised polyester main component of the present invention by subjecting ester derivatives of terephthalic acid and isophthalic acid such as a dialkyl terephthalate and a dialkyl isophthalate, and ethylene glycol to an ester interchange reaction, and further polycondensing the reaction product. The transesterification of ester derivatives is typically carried out in the presence of catalysts like a compound comprising Mn. The polycondensation proceeds typically with a germanium catalyst. A phosphorus based scavenger is added at the end of the transesterification

Preferably the alkyl groups in said ester derivatives are methyl groups.

In the production of the copolymerized polyester main component, a germanium comprising compound is preferably used, whether or not in the presence of Mn and phosphorus derivatives. This generally results in a germanium comprising catalyst residue in an amount between 10 and 500 ppm, preferably between 10 and 200 ppm and more preferably between 10 and100 ppm.

The polyester main component comprised 1,2-ethanediol and two dicarboxylic acid components, the dicarboxylic acid components comprising a terephthalic acid component and 4-20 mol %, of an isophtalic acid component. Below 4 mol % we found an undesirable increase in haze, while above 20 mol % the melting temperature became too low, thus causing storage problems. The dicarboxylic acid components preferably comprises a terephthalic acid component and 4-10 mol %, of an isophtalic acid component, as with more than 10 mol % the preferred melt dusting process to mix the main component with the at least one dye and mould release is not possible.

The copolymerised polyester component of the present invention further comprises from 0.2 to 1.5 ppm of at least one dye and from 0.1 to 0.5 m % of stearylstearate or glyceroltristearate. The at least one dye and mould release agent can be mixed with the copolymerised polyester component by a melt dusting or compounding process. The polyester compound is preferably mixed with from 0.2 to 1.5 ppm of at least one dye and from 0.1 to 0.5 m % of stearylstearate or glyceroltristearatedy by a melt dusting process, as this results in a b value closer to zero. Alternatively these components can be provided during the production process of the polyester. Preferably the stearates are present in an amount of between 0.15 and 0.50 m %, more preferably between 0.20 and 0.30 m %. Preferably stearylstearate is used.

In the moulding composition of the present invention preferably the at least one dye is chosen from a substituted anthraquinone. Preferably the substituted anthraquinone is a mixture of Solvent Blue 97 and Solvent Violet 36.

A moulding composition for producing transparent polyester articles is known from U.S. Pat. No. 3,842,043. U.S. Pat. No. 3,842,043 describes in Example 48 a process wherein a polyester is made from ethylene glycol, dimethyl terephthalate and dimethyl isophthalate with GeO₂ as a catalyst. The resulting polymer is claimed to be colourless and transparent. A disadvantage of the composition described in U.S. Pat. No. 3,842,043 is that a transparent article made from this composition is still slightly yellow seen in a direction parallel to a surface of the article. Another disadvantage of the composition described in U.S. Pat. No. 3,842,043 is that mouldings forces to release the article from a mould are relatively high.

A composition according to the present invention preferably has a relative solution viscosity (RSV) as measured in a solution of 0.5 g of polymer in 100 ml of dichloro-acetic acid at 25° C. (according to ISO 1628-5) of from 1.35-1.48 preferably between 1.38-1.44.

If the RSV is less than 1.35, the strength of the polyester obtained is so low that it is impossible to obtain practically necessary physical properties when the polyester moulded into an article. On the other hand, if the RSV exceeds 1.48, the melting viscosity becomes so high as to make injection moulding difficult.

A composition of the present invention is generally injection moulded to an article of between 1 and 3 mm wall thickness at a mould temperature of below 60° C., preferably between 40 and 50° C., and preferably at a melt temperature of between 260 and 290° C. A mould temperature in said range requires relatively low release forces to release the article from the mould, while the article has a reduced or no yellowness, seen in a direction parallel to a surface of the moulding.

The present invention will now be described in more detail with reference to the following examples and comparative examples, which serve to illustrate the essential characteristics and considerable advantages thereof.

### EXAMPLES

### 1. Preparation of Copolyesters

A double wall, oil heated stainless steel reactor equipped with stirrer, thermocouple, and partial reflux type condenser was charged with 1,2-ethanediol, 20.8 kg, dimethylterephthalate, 27.3 kg and dimethylisophthalate, 3 kg. The reactor was purged during 5 minutes with nitrogen, thereafter a blanketing flow of 70 l/hr. nitrogen was maintained and the transesterification catalyst manganese(II)acetate tetrahydrate, 10.25 g added as a solution in 1,2-ethanediol. The reactor was heated at atmospheric pressure under nitrogen and transesterification started at 166° C., the product temperature further rose to 240° C. and when transesterification had ended, a 35 kP vacuum was drawn. Atmospheric pressure was regained and a germanium dioxide based catalyst (4.55 g) in 1,2-ethanediol in the presence of a phosphorus based sequestering agent was added.

The transesterified product was then pumped under atmospheric pressure to a 50 L double walled oil heated stainless steel autoclave equipped with electric motor driven stirrer with torque measurement, thermocouple and vacuum system.

The product temperature was allowed to rise from 240° C. to end temperature of 285° C. in about 2 hours, while vacuum was gradually decreased from 350 mbar to 60 P. Stirring was kept constant at 20 RPM, allowing torque measurement for viscosity steering.

When a torque of 30 Nm was reached, the reactor was nitrogen pressurised to 4 bar and the polymer melt extruded at the bottom of the reactor. After cooling and solidifying on a cooling belt, the copolyester strand was granulated. The RSV of this copolyester was 1.42.

### 2. Preparation of the Moulding Compound Comprising Dyes and Mould Release Agent

2.a Preparation of Mould Release Agent-Dyes Masterbatch
Into a 2L beaker is weighed 1 kg mould release agent, and 1 g of one or more dyes). The contents are slowly heated to 80° C. while stirring.
The molten liquid is then poured in a thin layer on an aluminium foil and let to solidify. The solid waxy layer is then crushed into flakes. In this way a mould release agent-dyes masterbatch, of 1 g dyes (Macrolex Blau RR, and Macrolex Violet 3R FG, e.g in a ratio 400 mg/600 mg) in 1 kg stearyl stearate, (e.g. Loxiol G32) is produced.
Mould release agents are e.g. stearyl stearate (Loxiol G32) or glyceroltristearate (Loxiol 728).
Macrolex Blau RR is used as Solvent Blue 97 and Macrolex Violet 3R FG is used as Solvent Violet 36.

2.b Preparation of Copolyester Moulding Compound With Mould Release Agent and Dyes
A 3000 L double walled, oil heated steel rotary dryer was charged with poly (ethylene terephthalate-co-(10 mol %) isophthalate) PET copolyester, 1000 kg, mould release, 2.910 kg and mould-release agent-dyes masterbatch, 0.602 kg, and deionised water, 5 kg. The dryer with contents was purged with nitrogen. A slow heating ramp was applied, heating up the product from room temperature to 140° C. in 15 hours. Vacuum was then applied for 2 hours at 140° C., whereupon the pellets were cooled down to 40° C. In this way a melt dusted copolyester with 0.35 m % mould release agent and 0.4 ppm dyes (Macrolex Blau RR and Macrolex Violet 3R) FG was produced. The ratio (m %/m %) of Macrolex Blau RR and Macrolex Violet 3R FG is given in table 1.

### Preparation of Plaques by Injection Moulding.

Plaques with dimension 80×80×2 mm have been injection moulded from pre-dried (10 hours at 120° C. under vacuum with nitrogen flow) granules on an Arburg 110 injection moulding machine with 30 mm diameter barrier screw. A nozzle of diameter 3 mm with a length of 60 mm was used to inject the material into a mould of 80×80×2mm with high gloss inserts (With ISO 4287 roughness parameter NO, hand polished).

Melt temperature settings of 270-280° C., and mould temperature of 15° C. and 50° C., respectively, have been used.

The release force (F release) has been measured during ejection of the plaques. A data acquisition system (Kistler Dataflow) was used for monitoring the mould release force, with a 2 ms sampling interval. As such, a load cell was installed between the machine's ejector and mould. In this set-up, the injection-moulded plate is pushed out of the mould at a controlled ejector speed by the ejector pins.

For each moulding cycle the force exerted by the ejector pins on the plate is measured during the ejection stage, which yields a force curve. The maximum of this force curve is recorded as the release force for a particular shot.

### 4. Description of Measurements

4.1 Colour Measurements.

The colour co-ordinates L*a*b* have been determined with the Minolta CM-3700d spectrophotometer using a Xenon light-source, according to ISO 7724-1-2-3. The colour was measured in reflectance at 23° C. on the 80×80×2 mm plaques; a white background, D65 illumination and geometry d/8° with observer 10°, and a round measuring area with a diameter of 25.4 mm have been used.

4.2 Optical Properties Haze & Transmittance

The method for measuring the haze value is described in the standard ASTM D 1003, procedure A. The method for measuring the haze value is described in the standard ASTM D 1003, procedure A. The D1003 test method covers the evaluation of specific light-transmitting and wide-angle-light-scattering properties of planar sections of materials such as essentially transparent plastic. Procedure A is to provide for the measurement of luminous transmittance and haze.

The haze value has been measured with a BYK Gardner XL-211 Hazegard System, using a halogen light source. The haze and transmittance is measured on 80×80×2 mm plaques.

TABLE 1

| | | T melt | Tmould | | Frelease | Haze | Transmission | | | |
|---|---|---|---|---|---|---|---|---|---|---|
| Exp. nr | Mould release | [° C.] | [° C.] | Dyes | [N] | [%] | [%] | L* | a* | b* |
| Comp 1 | — | 278 | 15 | | 2500 | 1.4 | 91.9 | | | |
| Comp 2 | — | 280 | 50 | | 1950 | 1.1 | 91.9 | 98.15 | −0.18 | 0.14 |
| Comp 3 | Loxiol 3591 | 282 | 15 | | 2040 | 5 | 90.6 | | | |
| Comp 4 | | 279 | 50 | | 1350 | 8 | 89.4 | 95.81 | −0.08 | 2.17 |
| Comp 5 | Loxiol G32 | 280 | 15 | | 1850 | 1.3 | 91.8 | | | |
| Comp 6 | | 278 | 50 | | 1300 | 1.8 | 91.8 | 97.97 | −0.21 | 0.38 |
| Example 1 | | 280 | 50 | Macrolex 50/50 (bl/vi) | 1250 | 1.5 | 91.7 | 97.86 | −0.2 | −0.06 |
| Example 2 | | 280 | 50 | Macrolex 60/40 (bl/vi) | 1230 | 1.6 | 91.7 | 97.81 | −0.27 | −0.02 |
| Example 3 | | 280 | 50 | Macrolex 40/60 (bl/vi) | 1280 | 1.3 | 91.6 | 97.88 | −0.14 | −0.1 |
| Comp. 7 | Loxiol P728 | 275 | 15 | | 2050 | 1.8 | 91.8 | | | |
| Comp 8 | | 278 | 50 | | 1230 | 1.6 | 91.8 | 97.95 | −0.22 | 0.48 |
| Example 4 | | 280 | 50 | Macrolex 50/50 (bl/vi) | 1290 | 1.8 | 91.5 | 97.8 | −0.19 | −0.02 |
| Comp. 9 | PETS | 281 | 15 | | 1780 | 86.6 | 71.3 | | | |
| Comp. 10 | | 282 | 50 | | 1180 | 84.1 | 69.6 | 97.8 | −0.15 | 0.43 |

Table 1 shows that with the method according to the invention a haze value of less than 2% and a b value between −1.0 and +0.1 in combination with a release force of less than 1300 N on plaques with a dimension of 80×80×2 mm can be obtained. In the method according to the invention, the mould temperature is preferably between 45 and 55° C., as at these temperatures, the lowest release forces are obtained during injection moulding of an article. With stearylstearate (Loxiol G32) best results in terms of the combination of b-value, haze and release force are obtained.

1. Method for injection moulding an article having a thickness of between 1 to 3 mm and having a b value in the CIE colour system of between −1 and +0.1 and a haze value of less than 2%, as measured at 2 mm thickness, comprising the following steps:
a. Providing a composition comprising:
i. a polyester produced by copolymerizing, in the presence of an aluminium or germanium compound, at least three monomers chosen from at least one alkylenediol and at least one dicarboxylic acid component, the third monomer being a alkylenediol or a dicarboxylic acid moiety,
ii. from 0.2 to 1.5 ppm of at least one dye
iii. and from 0.1 to 0.5 m % of a fatty acid ester mould release agent
b. Injecting the composition in a mould at a temperature of below 60° C. until the mould is filled;

2. Method according to claim 1, wherein the polyester, the at least one dye and the mould release agent are mixed by a melt-dusting process.

3. Composition comprising,
(A) a polyester produced by copolymerizing 1,2-ethanediol and two dicarboxylic acid components in the presence of a germanium compound, the dicarboxylic acid components comprising a terephthalic acid component and 4-20 mol % of an isophthalic acid component, the mol % being relative to the total amount of the dicarboxylic acid component, characterised that the composition further comprises
(B) from 0.2 to 1.5 ppm of at least one dye
(C) from 0.1 to 0.5 m % of stearylstearate or glyceroltristearate

4. Composition according to claim 3, wherein the terephthalic acid component is a dialkyl terephthalate and the isophthalic acid component is dialkyl isophthalate.

5. Composition according to claim 4, wherein the alkyl groups are methyl groups.

6. Composition according to claim 3, further comprising a catalyst residue comprising Ge or Al in an amount between 10 and 500 ppm.

7. Composition according to claim 3, wherein the mould release agent comprises stearylstearate.

8. Composition according to claim 3, wherein the at least one dye is chosen from one or more anthraquinone dyes.

9. Composition according to claim 8, wherein the one or more anthraquinone dyes comprise Solvent Blue 97 and Solvent Violet 36.

10. Article having a wall thickness of between 1 and 3 mm, comprising the composition of claim 9.
